(19) United States
(12) Patent Application Publication
(10) Pub. No.: US 2009/0295682 A1
(43) Pub. Date: Dec. 3, 2009

(54) METHOD FOR IMPROVING SENSOR DATA COLLECTION USING REFLECTING USER INTERFACES

(75) Inventors: Pernilla Qvarfordt, Los Altos, CA (US); Anthony Dunnigan, Berkeley, CA (US)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/130,978

(22) Filed: May 30, 2008

(51) Int. Cl. G09G 5/00

(52) U.S. Cl. 345/8

(57) ABSTRACT

One challenge with using sensing devices to collect information about a person is that the person needs to stay within reach of sensor. Several solutions exist to resolve this issue, some relay on improving the machinery of the sensor, while other relay on constraining the movements of the person tracked. Both these methods have limitations. In this invention proposal, we describe a method for improving data collection without restraining the user unnecessary or that require a leap in sensor technology. By providing subtle feedback of the sensor's field of sensitivity in the form of a reflecting UI, the user can adjust his or her position in front of the sensor to improve the data collection.

### DESCRIPTION OF THE INVENTION

1. Field of the Invention

This invention generally relates user interfaces and more specifically to user interfaces with sensing capability and also relates to reflective user interfaces.

2. Description of the Related Art

Various sensors are becoming a ubiquitous part of computers and computing devices such as mobile phones. However, in order to fully take advantage of the information collected from various sensors, the user needs to stay within the range of the sensor. When the data from the sensors are used as an input device, reliable signal from the sensors are essential. The sensing technology most commonly used today for computer input is eye tracking.

Eye tracking is a promising computer input technique for disabled users or as a complement to existing input methods particular when a mouse is not appropriate or when the users' hands already are occupied. However, eye tracking is sensitive to a number of factors, such as light conditions, characteristics of the user's eye and if the target, the eye, is within the field of view of the eye tracker. Some of the factors influencing the performance of the eye trackers are possible to control; it is possible to keep the light conditions stable. While others are impossible to control, such as the characteristics of the user's eye.

Keeping the user within the field of view has been a concern since the early days of eye tracking. Solutions such as bite bars and chin rest as early solutions still in use to day, for instance SR International sells an eye tracker (Eye Link 1000) 100 with built in chin rest 101, as shown in FIG. 1 and described in SR Research, 2007, EyeLink. Besides the chin rest 101, the system 100 uses a forehead rest 107 in order to secure the user's eyes within the field of view of the eye tracker. Other components of the system 100 include 1000 Hz infrared camera used in acquiring images (video) of the eye movements, eye selection knob 108, IR illuminator 105, external light balling 104 and an infra-red reflective mirror 102 with the mirror angle adjustment control 103.

Another solution is a head mounted eye tracker, such as iView commercially available from SMI (SensoMotoric Instruments). However, even light weight solutions, such as the iView from SMI, require the user to be attached to a computer. This method is not preferred when using eye tracking as a computer input device, since the user's field of view is recorded by a camera and the gaze information is in relation to this recording. Finding out exactly where on a computer screen a user is looking, would require video analysis of user's video stream. Some eye trackers allow the users a limited range of head motion. These are generally table mounted eye trackers. FIG. 2 illustrate the field of view area 201 in x- and y-axis that the state-of-the-art commercial eye tracker, the Tobii eye tracker, well known to persons of skill in the art, allows.

The problem of maintaining a user within the field of view of the eye tracker has attracted much research. Solutions vary, but the most common is to emply a system incorporating moving cameras. One such system is described in Beymer, D. and Flickner, M., 2003, Eye gaze tracking using an active stereo head, In Proceedings of 2003 IEEE Computer Society Conference on Computer Vision and Pattern Recognition, Pp. 451-458. The technique of using moving cameras will soon become available in a commercial eye tracker developed by LC Technology. However, the high cost of these eye trackers may prevent them from entering the market place outside research laboratories. As would be appreciated by persons of skill in the art, low costing solutions are preferred, in particular if they are easy to implement.

Another solution for keeping the user within the field of the eye tracker is to make the user aware of if he or she is in the field of view of the eye tracker. One method is to display the user's gaze location on the screen. This method is common when eye tracking is used as an input method. However, this is a far from optimal method. The eye movements are quite jittery, resulting in a constantly jumping eye cursor. Also, the eye cursor does not signal to the user how to adjust to be better tracked by the eye tracker. Another method is to show the camera view, or a representation of the camera view, in a separate window. However with this method, the users need to keep an eye on that window, which interrupts their natural interaction with the computer.

Therefore, it is desirable to have a low cost solution for keeping user's eyes within a field of view of the eye tracker.

### SUMMARY OF THE INVENTION

The inventive methodology is directed to methods and systems that substantially obviate one or more of the above and other problems associated with conventional techniques for tracking user's movements.

In accordance with one aspect of the inventive concept, there is provided a user interface system with sensing capability. The inventive system incorporates a sensor having a field of sensitivity; a camera configured to create an image of a user; a sensing module generating information indicative of movements of the user, and a display module coupled at least to the camera and sensing module and configured to provide the user a feedback based on the image and the information indicative of the movements of the user, the feedback being co-located with one or more objects in a work area of the user.

In accordance with another aspect of the inventive concept, there is provided a method for sensing movements of a user. The inventive method involves: obtaining information about the user using a sensor having a field of sensitivity; obtaining an image of the user using a camera; generating information indicative of movements of the user; and providing the user a feedback based on the image and the information indicative of the movements of the user, the feedback being co-located with one or more objects in a work area of the user.

In accordance with yet another aspect of the inventive concept, there is provided a computer readable medium embodying a set of instructions, which, when executed by one or more processors cause the one or more processors to perform a method for sensing movements of a user. The aforesaid method involves: obtaining information about the user using a sensor having a field of sensitivity; obtaining an image of the user using a camera; generating information indicative of movements of the user using a sensing module; and providing the user a feedback based on the image and the information indicative of the movements of the user, the feedback being co-located with one or more objects in a work area of the user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates Eye Link 1000 commercial eye tracker from SR International.

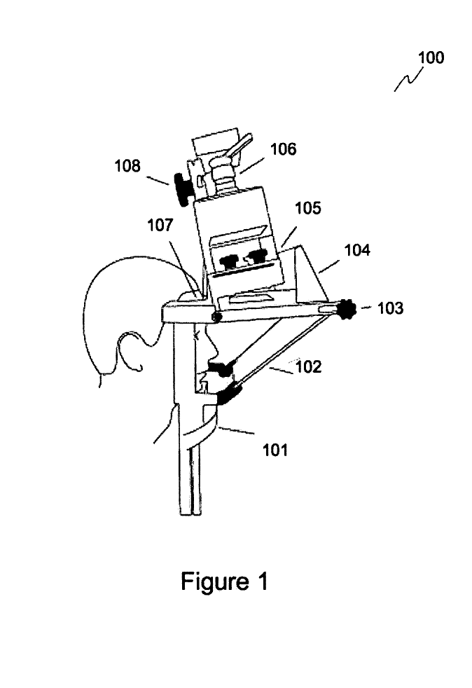

FIG. 2 shows an approximate size of the field of view of the Tobii commercial eye tracker.

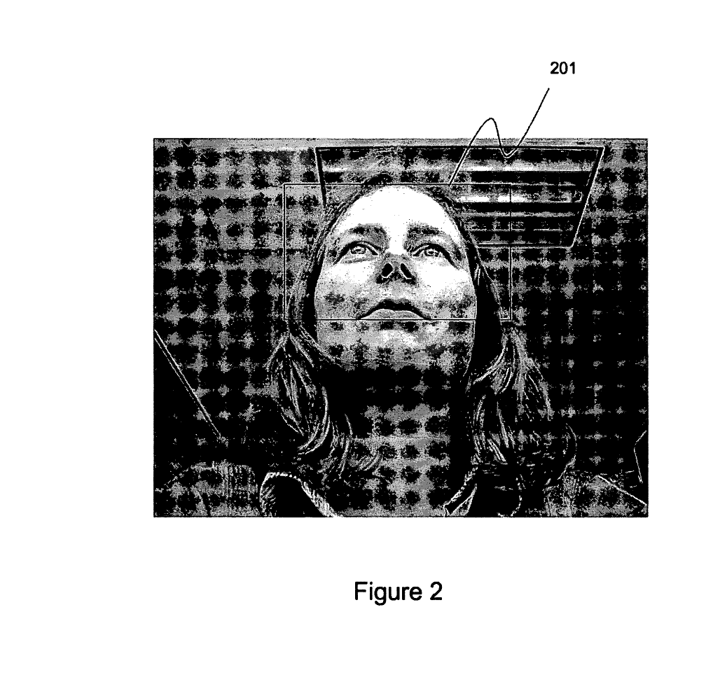

FIG. 3 illustrates an exemplary embodiment of a reflective user interface.

FIG. 4(a) illustrates an exemplary view from an eye tracker.

FIG. 4(b) illustrates an exemplary view from an auxiliary camera.

FIG. 5 illustrates a change of alpha value depending on relation to the optimal position of user in front of an eye tracker.

FIG. 6 illustrates exemplary operating sequence of an embodiment of the inventive system.

FIG. 7 illustrates an exemplary embodiment of an inventive system.

FIG. 8 illustrates an exemplary embodiment of a computer platform upon which the inventive system may be implemented.

### DETAILED DESCRIPTION

In the following detailed description, reference will be made to the accompanying drawings, in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

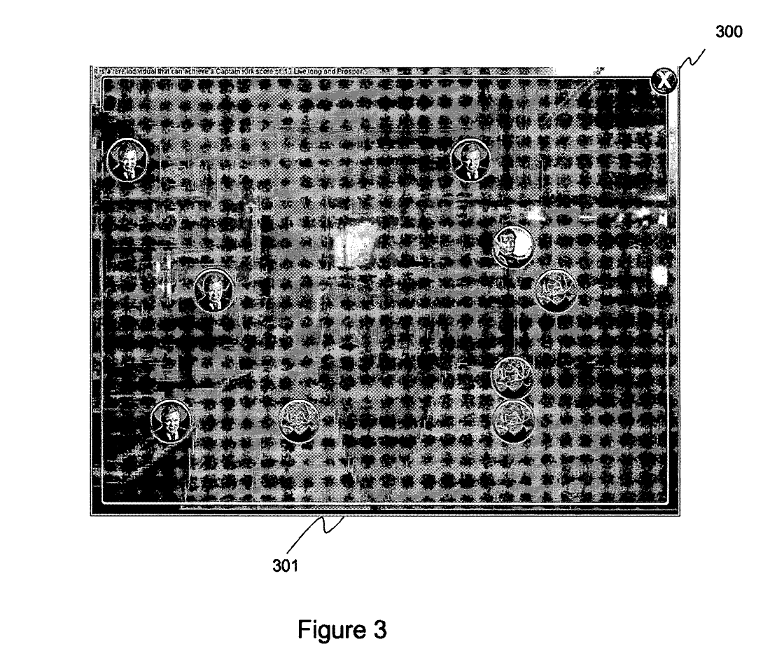

In accordance with an embodiment of the inventive concept, there is provided a novel approach for improving the data collection from an eye tracker with free head motions. Instead of costly hardware improvements to the eye trackers, the embodiment of the invention instruments the user interfaces with attractive and esthetically pleasing reflections of the user, so called reflective user interfaces. An exemplary embodiment of a reflective user interface is described in detail in U.S. patent application Ser. No. 12/080,675. The reflective user interface makes the users aware of their movements in a subtle way that does not disturb the interaction or the user experience. An example of a reflective user interface 300 is shown in FIG. 3. The exemplary user interface 300 shown in FIG. 3, displays image 301 of the user(s). The image 301 is displayed to the user(s) themselves so that the user(s) become aware of their movements.

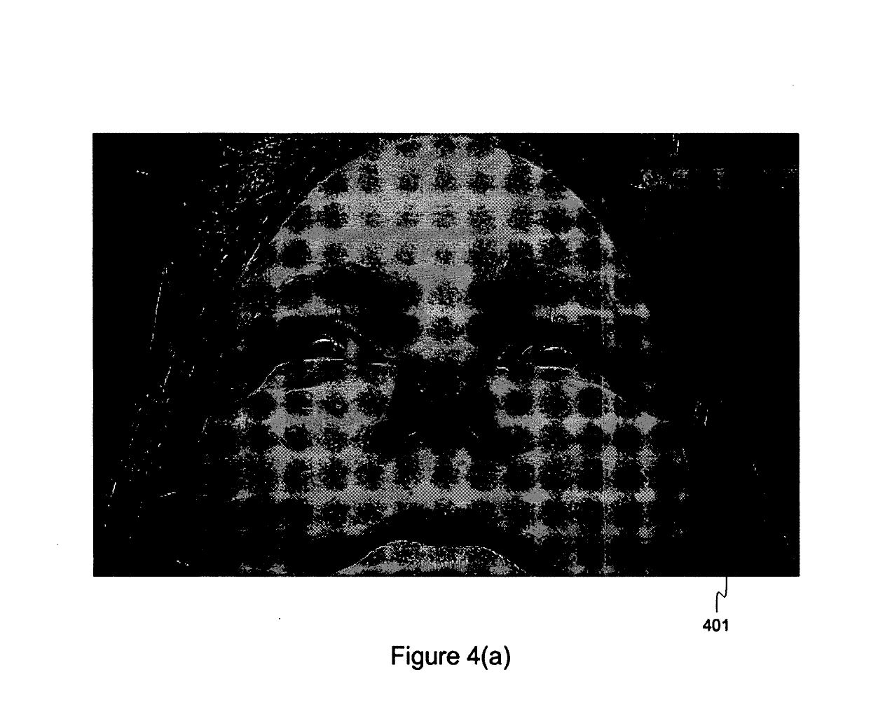

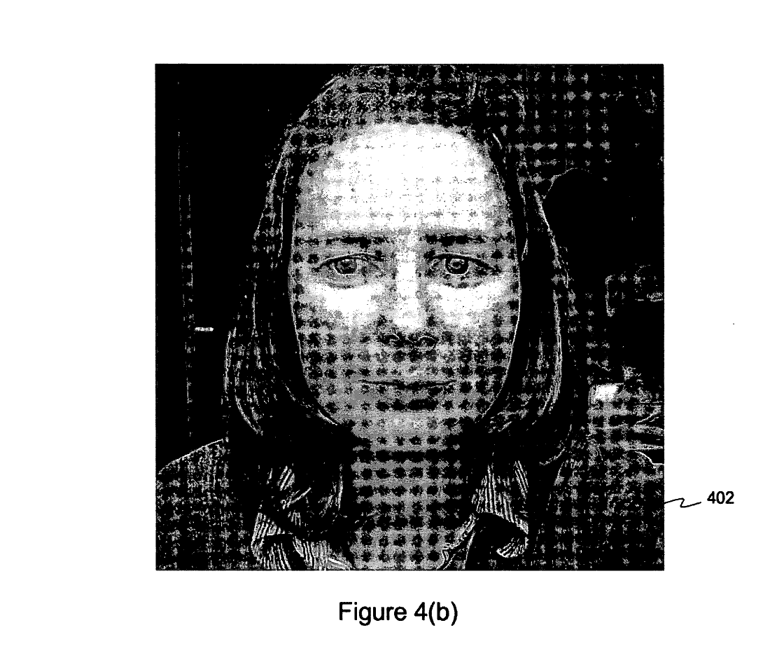

The aforesaid U.S. patent application Ser. No. 12/080,675 describes how to construct the reflective user interface. When adapting the reflective user interfaces for the purpose of improving gaze data collection, it would be possible to get the camera image directly from the sensor's camera, for instance the eye tracker. However, this method has two main limitations, when used with eye trackers. First of all, eye trackers use infrared cameras. Since the image is not captured under natural light condition, the resulting image would not match the user's expectation of a mirrored image. In addition, the image generated by the eye tracker is not taken from the most attractive angle, as illustrated in FIG. 4(a). Specifically, FIG. 4(a) illustrates a representative view 401 from an eye tracker. It should be noted that while the angle of the image in FIG. 4(a) generally represents the angle of view from the eye tracker, the actual image generated by the eye tracker is usually darker, in particular the background, and with more pronounced reflections.

Instead of using the image of the eye tracker for generating the reflective user interface, in accordance with an embodiment of the inventive concept, a simple auxiliary camera is used. The auxiliary camera can be of a type that is used in webcams, and may be located on the top of the user's screen instead as from the bottom of it as would be the angle of view of the eye tracker. As would be appreciated by persons of ordinary skill in the art, the angle of the reflection from this camera would not be the same as with the image from the eye tracking camera, compare FIG. 4(a) with FIG. 4(b), which provides an illustrative image of the user 402. However, this fact does not affect the operation of the reflective user interface. A smaller field of view of the eye tracker camera can be simulated by cropping the video stream from the auxiliary camera (e.g. webcam) so that only the center part of the video stream is used for the reflection.

In one embodiment of the invention, the cropped center portion of the image coincides with the actual field of view of the eye tracker camera. In another embodiment of the invention, the cropped video stream does not need to directly correspond to the field of view of the eye tracker since we have observed that people unconsciously try to position themselves so that their reflection is in the center of the camera's field of view.

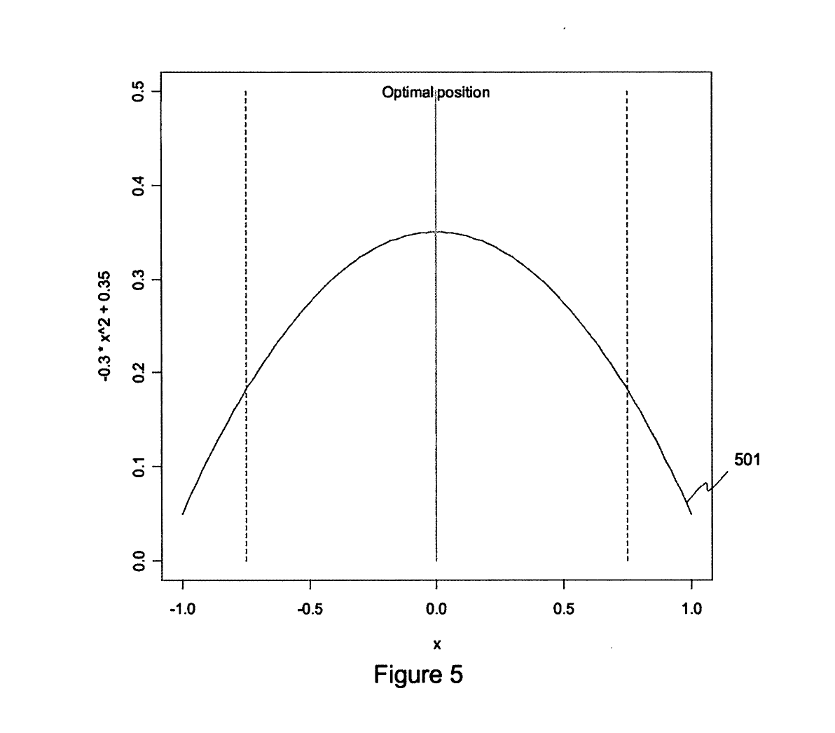

The cropped image from the auxiliary camera would only give the user a sense of their position along the eye trackers x- and y-axis. But a user of an eye tracker may also get out of range by moving too close or too far away from the eye tracker. Information the user about their optimal position in front of the eye tracker in the z-axis is important for the x- and y-axis. In one embodiment of the invention, the distance information provided by the eye tracker is used to give the user a cue that they are moving out of range of the eye tracker. This cue is implemented simply by changing the alpha value of the video stream so that the reflection melts into the background and the user reflection completely disappears when the user is out of range. On the other hand, the reflection will be the most vivid when the user is located at optimal distance from the eye tracker camera. FIG. 5 illustrates exemplary change 501 of alpha value depending on relation to the optimal position of user in front of an eye tracker.

Thus, an embodiment of the invention provides a feedback by manipulating the image from a secondary video source rather from the video source of the sensing device, in this case the eye tracker. This permits the feedback to be non-intrusive, subtle and attractive to the user. In one embodiment of the invention, the feedback is in a form of a reflective image of the user. To minimize the user's distraction, the feedback may be co-located with the user's work area. Specifically, in one embodiment, the image of the user generated by the reflective user interface is placed on the background or the foreground of the graphical user interface window currently used by the user. In another embodiment, the reflective image of the user is placed on the background of the graphical user interface itself. As would be appreciated by those of skill in the art, the present invention is not limited to any specific location of the user's feedback. Other convenient locations for delivering the feedback to the user may be utilized.

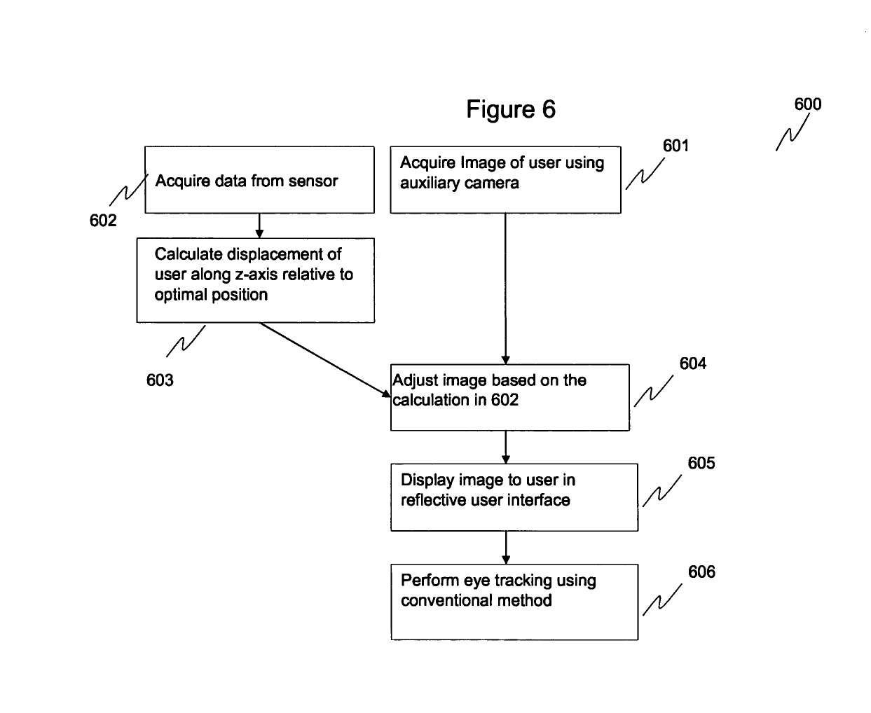

FIG. 6 illustrates an exemplary operating sequence 600 of an embodiment of the inventive concept. At step 601, an image of the user is created using the auxiliary camera. At step 602, a data from the sensor is acquired. At step 603, the displacement of the user along z axis relative to the optimal distance to the eye tracker is calculated using the sensor data. The optimal distance is calculated based on information about the user's initial location in the y-axis within the field of view of the eye tracker and initial estimated distance to the eye tracker. Both measurements can be provided by the eye tracker, or by using other sensing devices. In accordance with the results of his calculation, the image taken by the auxiliary camera is adjusted in step 604. In one embodiment of the invention, the adjustment may include, without limitation, adjusting the value of the alpha of the image. In another embodiment, the adjustment may include adjusting one or all color channels of the image to get an image tinted by one color or without any colors at all, wherein the image with original colors or near to original colors would correspond to the optimal location of the user with respect to the eye tracker. Other possible embodiments include blurring the image. At step 605, the adjusted image of the user is displayed to the user in the reflective user interface such that the user is encouraged to position himself or herself in the center of the image and at the optimal distance from the eye tracker. Finally, at step 606, the user's eye movement is tracked using the image generated by the eye tracker camera and a conventional eye tracking techniques.

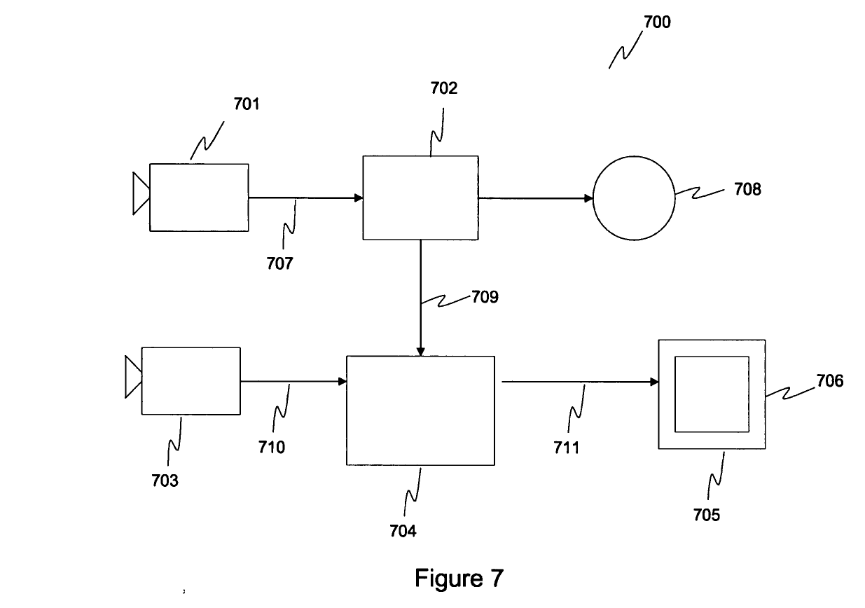

FIG. 7 illustrates an exemplary configuration of an embodiment of the invention system 700. The depicted embodiment includes an eye tracker camera 701, which takes images of 707 of the user. These images 707 are used by an eye tracking module 702 to generate information 708, which is indicative of the eye movements of the user. The system 700 further includes a auxiliary camera 703 (which may be a webcam), which produces a second images of the user 710. This image is adjusted by an image adjustment module 704 based, for example, on the distance information 709, which is furnished by the eye tracker module 702. The distance information is indicative of the distance between the eye tracker camera and the user. In addition, the adjustment module 704 may also appropriately crop the image 710. The adjusted and/or cropped image of the user is provided back to the user using a reflective user interface 706 displayed in the display 705.

As would be appreciated by persons of ordinary skill in the art, the auxiliary camera is not limited to a webcam, but may be implemented using any known technology, which enables a digital image of the user to be acquired.

It should be also noted that the present invention is not limited to use of reflective user interface for facilitating eye tracking. It should be noted that eye tracking is just one instance of using a sensor to collect information about users location in front of a computer. The inventive concept involving using a reflective user interface can be also applied to face tracking and motion sensors (for instance for playing a game on game console) and other similar devices.

### Exemplary Computer Platform

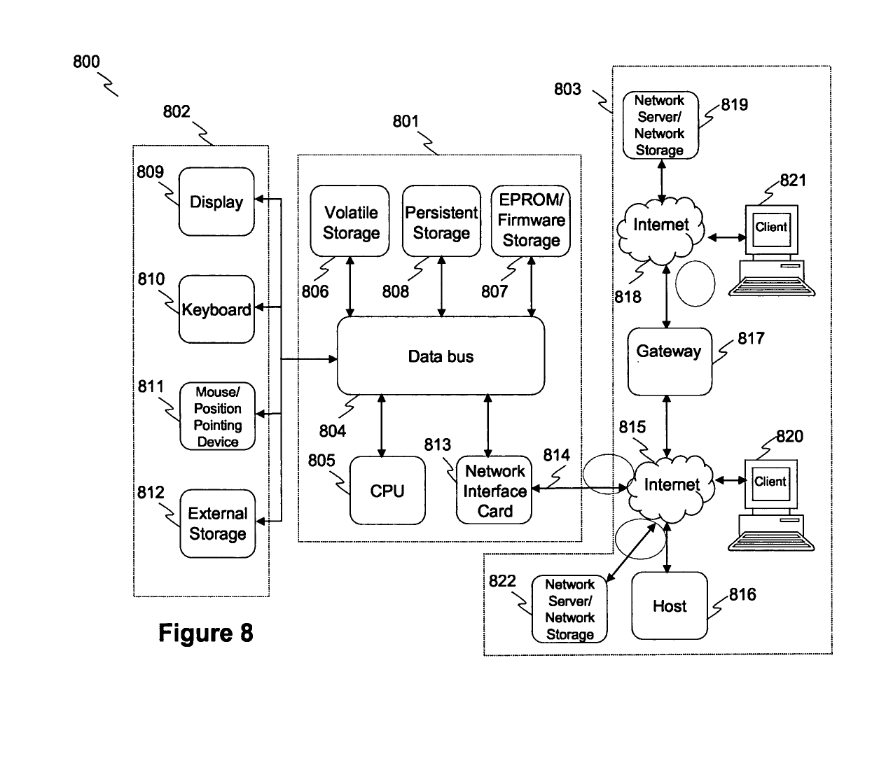

FIG. 8 is a block diagram that illustrates an embodiment of a computer/server system 800 upon which an embodiment of the inventive methodology may be implemented. The system 700 includes a computer/server platform 701, peripheral devices 702 and network resources 703.

The computer platform 701 may include a data bus 704 or other communication mechanism for communicating information across and among various parts of the computer platform 701, and a processor 705 coupled with bus 701 for processing information and performing other computational and control tasks. Computer platform 701 also includes a volatile storage 706, such as a random access memory (RAM) or other dynamic storage device, coupled to bus 704 for storing various information as well as instructions to be executed by processor 705. The volatile storage 706 also may be used for storing temporary variables or other intermediate information during execution of instructions by processor 705. Computer platform 701 may further include a read only memory (ROM or EPROM) 707 or other static storage device coupled to bus 704 for storing static information and instructions for processor 705, such as basic input-output system (BIOS), as well as various system configuration parameters. A persistent storage device 708, such as a magnetic disk, optical disk, or solid-state flash memory device is provided and coupled to bus 701 for storing information and instructions.

Computer platform 701 may be coupled via bus 704 to a display 709, such as a cathode ray tube (CRT), plasma display, or a liquid crystal display (LCD), for displaying information to a system administrator or user of the computer platform 701. An input device 710, including alphanumeric and other keys, is coupled to bus 701 for communicating information and command selections to processor 705. Another type of user input device is cursor control device 711, such as a mouse, a trackball, or cursor direction keys for communicating direction information and command selections to processor 704 and for controlling cursor movement on display 709. This input device typically has two degrees of freedom in two axes, a first axis (e.g., x) and a second axis (e.g., y), that allows the device to specify positions in a plane.

An external storage device 712 may be connected to the computer platform 701 via bus 704 to provide an extra or removable storage capacity for the computer platform 701. In an embodiment of the computer system 700, the external removable storage device 712 may be used to facilitate exchange of data with other computer systems.

The invention is related to the use of computer system 700 for implementing the techniques described herein. In an embodiment, the inventive system may reside on a machine such as computer platform 701. According to one embodiment of the invention, the techniques described herein are performed by computer system 700 in response to processor 705 executing one or more sequences of one or more instructions contained in the volatile memory 706. Such instructions may be read into volatile memory 706 from another computer-readable medium, such as persistent storage device 708. Execution of the sequences of instructions contained in the volatile memory 706 causes processor 705 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 705 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 708. Volatile media includes dynamic memory, such as volatile storage 706. Transmission media includes coaxial cables, copper wire and fiber optics, including the wires that comprise data bus 704. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 705 for execution. For example, the instructions may initially be carried on a magnetic disk from a remote computer. Alternatively, a remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on the data bus 704. The bus 704 carries the data to the volatile storage 706, from which processor 705 retrieves and executes the instructions. The instructions received by the volatile memory 706 may optionally be stored on persistent storage device 708 either before or after execution by processor 705. The instructions may also be downloaded into the computer platform 701 via Internet using a variety of network data communication protocols well known in the art.

The computer platform 701 also includes a communication interface, such as network interface card 713 coupled to the data bus 704. Communication interface 713 provides a two-way data communication coupling to a network link 714 that is connected to a local network 715. For example, communication interface 713 may be an integrated services digital network (ISDN) card or a modem to provide a data communication connection to a corresponding type of telephone line. As another example, communication interface 713 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 713 sends and receives electrical, electromagnetic or optical signals that carry digital data streams representing various types of information.

Network link 713 typically provides data communication through one or more networks to other network resources. For example, network link 714 may provide a connection through local network 715 to a host computer 716, or a network storage/server 717. Additionally or alternatively, the network link 713 may connect through gateway/firewall 717 to the wide-area or global network 718, such as an Internet. Thus, the computer platform 701 can access network resources located anywhere on the Internet 718, such as a remote network storage/server 719. On the other hand, the computer platform 701 may also be accessed by clients located anywhere on the local area network 715 and/or the Internet 718. The network clients 720 and 721 may themselves be implemented based on the computer platform similar to the platform 701.

Local network 715 and the Internet 718 both use electrical, electromagnetic or optical signals that carry digital data streams. The signals through the various networks and the signals on network link 714 and through communication interface 713, which carry the digital data to and from computer platform 701, are exemplary forms of carrier waves transporting the information.

Computer platform 701 can send messages and receive data, including program code, through the variety of network(s) including Internet 718 and LAN 715, network link 714 and communication interface 713. In the Internet example, when the system 701 acts as a network server, it might transmit a requested code or data for an application program running on client(s) 720 and/or 721 through Internet 718, gateway/firewall 717, local area network 715 and communication interface 713. Similarly, it may receive code from other network resources.

The received code may be executed by processor 705 as it is received, and/or stored in persistent or volatile storage devices 708 and 706, respectively, or other non-volatile storage for later execution. In this manner, computer system 701 may obtain application code in the form of a carrier wave.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in a user interface with an eye tracking capability. It is intended that the specification and examples be considered as exemplary only, with a true scope and spirit of the invention being indicated by the following claims.

What is claimed is:

1. A user interface system with sensing capability, the system comprising:
a. A sensor having a field of sensitivity;
b. A camera operable to create an image of a user;
c. A sensing module operable to generate information indicative of movements of the user, and
d. A display module operatively coupled at least to the camera and sensing module and operable to provide the user a feedback based on the image and the information indicative of the movements of the user, the feedback being co-located with one or more objects in a work area of the user.

2. The system of claim 1, wherein the sensor comprises a second camera operable to track the movements of the user.

3. The system of claim 1, wherein the feedback comprises at least a portion of the image of the user.

4. The system of claim 1, wherein the at least a portion of the feedback provided to the user is indicative of the field of sensitivity of the sensor.

5. The system of claim 1, wherein the feedback is indicative of a position of the user relative to an optimal position.

6. The system of claim 1, wherein the feedback is provided to the user on a background of an open window displayed using the display module.

7. The system of claim 1, wherein the feedback is provided to the user on a foreground of an open window or an object displayed using the display module.

8. The system of claim 1, wherein the feedback is provided to the user on a background of a graphical user interface displayed using the display module.

9. The system of claim 1, wherein the feedback is provided to the user on a foreground of a graphical user interface displayed using the display module.

10. The system of claim 1, further comprising image adjusting module operable to adjust an image displayed to the user based on at least
a displacement of the user relative to an optimal position with respect to the sensor.

11. The system of claim 10, wherein adjusting the image displayed to the user comprises changing characteristics of the image displayed to the user.

12. The system of claim 10, wherein adjusting the image displayed to the user comprises changing an alpha parameter of the image displayed to the user.

13. The system of claim 10, wherein adjusting the image displayed to user comprises changing color parameters of the image displayed to the user.

14. The system of claim 1, further comprising image adjusting module operable to crop an image displayed to the user based on the field of sensitivity of the sensor.

15. The system of claim 1, wherein the camera is an auxiliary webcam.

16. The system of claim 1, wherein the sensor is pointed at the user at an angle different from the camera.

17. A method for sensing movements of a user, the method comprising:
a. Obtaining information about the user using a sensor having a field of sensitivity;
b. Obtaining an image of the user using a camera;
c. Generating information indicative of movements of the user; and
d. Providing the user a feedback based on the image and the information indicative of the movements of the user, the feedback being co-located with one or more objects in a work area of the user.

18. The method of claim 17, wherein the sensor comprises a camera operable to perform motion tracking and wherein the information about the user is indicative of the movements of the user.

19. The method of claim 17, wherein the feedback comprises at least a portion of the image of the user.

20. The method of claim 19, wherein the at least a portion of the image provided to the user is indicative of the field of sensitivity.

21. The method of claim 17, wherein the feedback is indicative of a position of the user relative to an optimal position.

22. The method of claim 17, wherein the feedback is provided to the user on a background of an open window displayed using the display module.

23. The method of claim 17, wherein the feedback is provided to the user on a foreground of an open window or an object displayed using the display module.

24. The method of claim 17, wherein the feedback is provided to the user on a background of a graphical user interface displayed using the display module.

25. The method of claim 17, wherein the feedback is provided to the user on a foreground of a graphical user interface displayed using the display module.

26. The method of claim 19, further comprising adjusting the image displayed to the user based on at least a displacement of the user relative to an optimal position with respect to the sensing device.

27. The method of claim 26, wherein adjusting the image displayed to the user comprises changing characteristics of the image displayed to the user.

28. The method of claim 27, wherein adjusting the image displayed to the user comprises changing an alpha parameter of the image displayed to the user.

29. The method of claim 27, wherein adjusting the second image comprises changing color parameters of the image displayed to the user.

30. The system of claim 19, further comprising cropping the image displayed to the user based on the field of sensitivity.

31. A computer readable medium embodying a set of instructions, which, when executed by one or more processors cause the one or more processors to perform a method for sensing movements of a user comprising:
a. Obtaining information about the user using a sensor having a field of sensitivity;
b. Obtaining an image of the user using a camera;
b. Generating information indicative of movements of the user using a sensing module; and
d. Providing the user a feedback based on the image and the information indicative of the movements of the user, the feedback being co-located with one or more objects in a work area of the user.

32. The computer readable medium of claim 31, wherein the sensor comprises a camera operable to perform motion tracking and wherein the information about the user is indicative of the movements of the user.
